(19) United States
(12) Patent Application Publication
(10) Pub. No.: US 2007/0000088 A1
(43) Pub. Date: Jan. 4, 2007

(54) HINGE ASSEMBLY AND FOLDABLE ELECTRONIC APPARATUS EMPLOYING THE SAME

(76) Inventors: Jun-Feng Mao, Shenzhen (CN); Wen-Jie Bao, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,374

(22) Filed: Mar. 20, 2006

(30) Foreign Application Priority Data
May 24, 2005 (CN) 200520058944.0

(51) Int. Cl. E05F 3/20

(52) U.S. Cl. 16/54

(57) ABSTRACT

A hinge assembly includes a hinge shaft. The hinge shaft includes a first shaft end and an opposite second shaft end. A blind hole axially extends a predetermined length from the first shaft end toward the second shaft end for partially accommodating and guiding a flexible cable, the portion of the flexible cable received in the blind hole is substantially configured to be spiral. A releasing slot for the flexible cable to pass therethrough axially extends in a wall portion of the hinge shaft and communicates with the blind hole.

### FIELD OF THE INVENTION

The present invention relates to a hinge assembly and, more particularly, to a hinge assembly with protecting structure and a foldable electronic apparatus employing the same.

### DESCRIPTION OF RELATED ART

Electronic apparatuses, such as portable disk players, notebook computers and mobile phones, have become more and more common and are currently in widespread use in the world. In order to fulfill the portable characteristic, the electronic apparatuses need to be designed as compact as possible. A foldable design is usually a good choice because it allows the device to be more space convenient when folded. Conventionally, a foldable electronic apparatus includes a cover, a base and a hinge assembly. The cover is pivotally coupled to the base via the hinge assembly.

As far as a foldable disk player is concerned, it generally includes a cover, a base and a hinge assembly 80 (as shown in FIG. 5). The hinge assembly 80 includes a hinge shaft 82, a mounting board 84 for securing the hinge shaft 82 to the cover or the base, and a through hole 86 axially defined through the hinge shaft 82.

The cover and the base are pivotally connected via the hinge assembly 80. The cover accommodates electronic components such as a display unit therein. The display unit can be a video monitor, a liquid crystal display, or the like. The base also accommodates various electronic components therein. These electronic components include, for example, an optical disk recording/reproducing module and a power supply. Understandably, it is necessary to electrically interconnect the display unit and the various electronic components. Such electrical connections are usually accomplished by using various types of electric cables. In use, the cover may be frequently opened or closed relative to the base. The electric cable can pass through the through hole 86 of the hinge assembly 80 in order to get protection to some extent. However, the electric cable is liable to be damaged if the electric cable is not enveloped well enough.

Therefore, a hinge assembly with a protecting structure and a foldable electronic apparatus employing the same are desired.

### SUMMARY OF INVENTION

A hinge assembly includes a hinge shaft. The hinge shaft includes a first shaft end and an opposite second shaft end. A blind hole axially extends a predetermined distance from the first shaft end toward the second shaft end for partially accommodating and guiding a flexible cable. The portion of the flexible cable is substantially spiraled through the blind hole. A releasing slot axially extends in a wall portion of the hinge shaft defining the blind hole and communicates with the blind hole for the flexible cable to pass therethrough.

Other advantages and novel features will become more apparent from the following detailed description of preferred embodiments when taken in conjunction with the accompanying drawings, in which:

### BRIEF DESCRIPTION OF DRAWINGS

FIG. 1 is an exploded, isometric view of a foldable disk player in accordance with an exemplary embodiment of the present invention;

FIG. 2 is an inverted, isometric view of the first hinge assembly of the foldable disk player of FIG. 1, with two screws being removed;

FIG. 3 is a cut-away, assembled view of the foldable disk player of FIG. 1, but showing the foldable disk player in an open state;

FIG. 4 is an enlarged view of a circled portion IV of FIG. 3; and

FIG. 5 is an isometric view of a conventional hinge assembly.

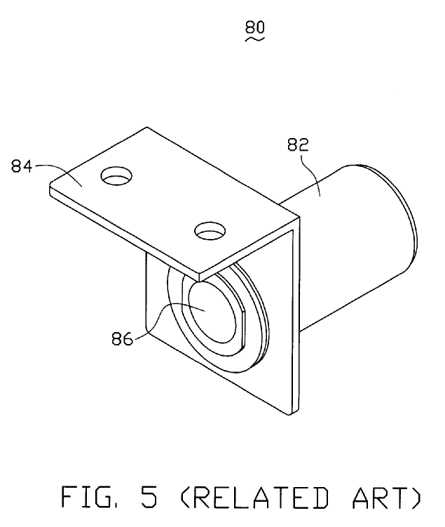

### DETAILED DESCRIPTION

Foldable electronic apparatuses can be foldable disk players, notebook computers, foldable mobile phones, and other apparatuses. In the following embodiments, a foldable disk player is used as an example for illustration.

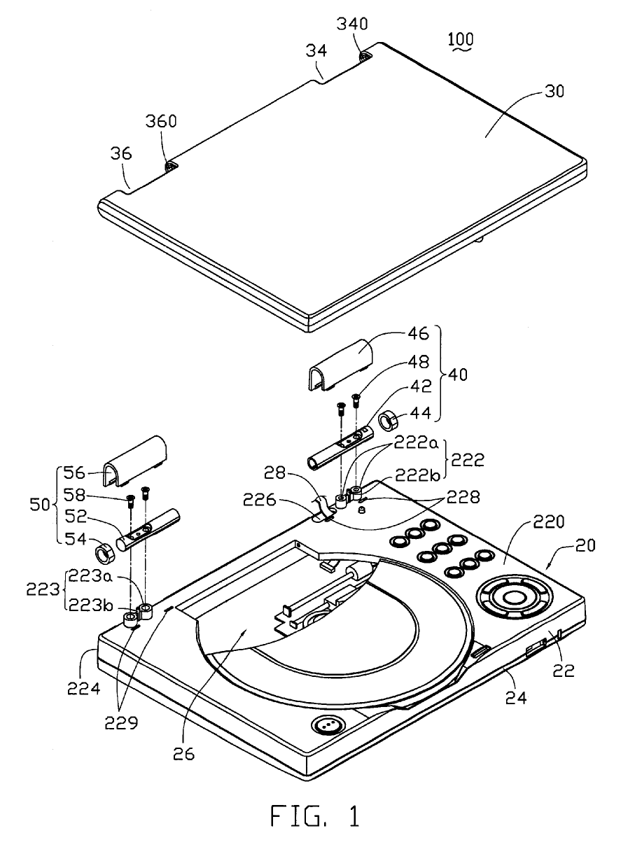

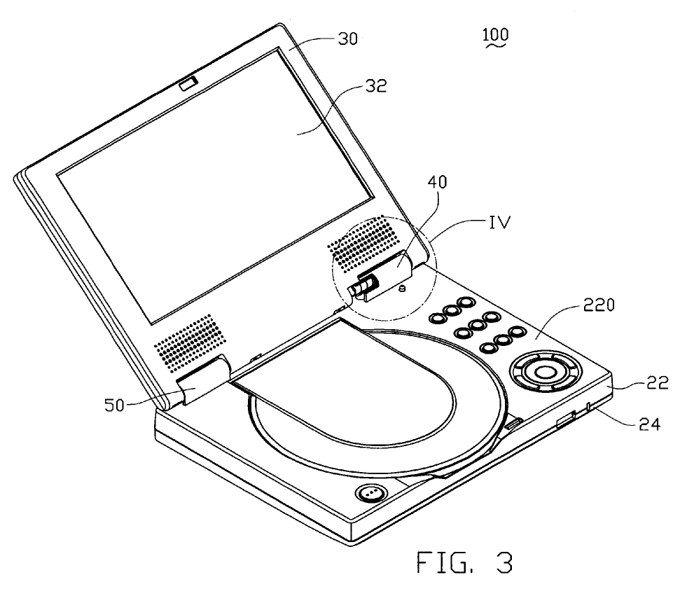

Referring to FIGS. 1 and 3, a foldable disk player 100 according to a preferred embodiment is illustrated. The foldable disk player 100 includes a base 20, a cover 30, a first hinge assembly 40 and a second hinge assembly 50. The cover 30 is pivotally coupled to the base 20 via the first and second hinge assemblies 40, 50.

The base 20 includes an upper casing 22, a lower casing 24, a traverse assembly 26 for recording/reproducing information on/from a disk (not shown), and a flexible cable 28 for interconnecting the electronic components integrated in the base 20 and the cover 30. The upper casing 22 and the lower casing 24 are detachably assembled together, for accommodating the traverse assembly 26 therein.

The upper casing 22 includes a top surface 220, a first bracket member 222, a second bracket member 223 and a rear side 224. The first and second bracket members 222, 223 are constructed on the top surface 220 and are juxtaposed adjacent to the rear side 224, for respectively supporting the first and second hinge assemblies 40, 50. The first bracket member 222 includes a pair of first columnar protrusions 222a and a first positioning pin 222b. The first positioning pin 222b is located between the pair of first columnar protrusions 222a. Each first columnar protrusion 222a defines a screw hole (not labeled) therein. The second bracket member 223 is similar to the first bracket member 222. The second bracket member 223 also includes a pair of second columnar protrusions 223a and a second positioning pin 223b. The second positioning pin 223b is located between the pair of second columnar protrusions 223a as well. Each second columnar protrusion 223a defines a screw hole (not labeled) therein, too.

A releasing hole 226 is defined in the top surface 220, for the flexible cable 28 to pass therethrough. The releasing hole 226 is close to and substantially in alignment with the first bracket member 222. A pair of first top mounting holes 228 is defined in the top surface 220 and arranged at a side of the first bracket member 222. A pair of first side mounting holes (not shown) is defined in the rear side 224.

Similarly, a pair of second top mounting holes 229 is defined in the top surface 220 and arranged at a side of the second bracket member 223. A pair of second side mounting holes (not shown) is also defined in the rear side 224.

The cover 30 accommodates a display unit 32 therein. First and second receiving portions 34 and 36 are coaxially defined at a bottom of the cover 30, for receiving the first and second hinge assemblies 40, 50 therein. The first and second receiving portions 34, 36 respectively correspond to the first and second bracket members 222 and 223. The first receiving portion 34 coaxially defines a pair of first receiving holes 340 in two opposite ends thereof. The second receiving portion 36 coaxially defines a pair of second receiving holes 360 in two opposite ends thereof.

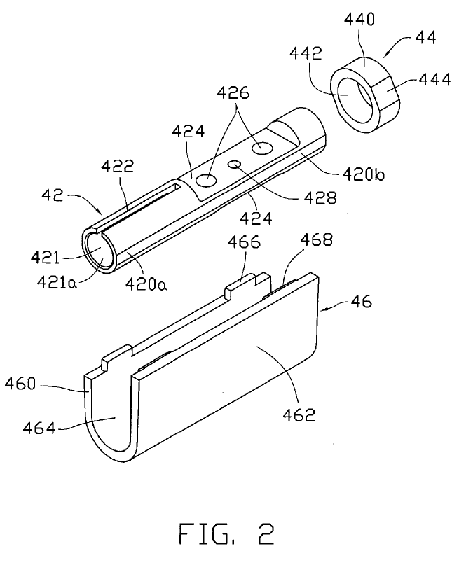

Referring to FIGS. 1, 2 and 3 together, the first and second hinge assemblies 40, 50 are respectively mounted to the corresponding first and second bracket members 222 and 223. The first hinge assembly 40 includes a first hinge shaft 42, a first positioning ring 44, a first hinge housing 46, and two first screws 48. The first hinge shaft 42 has a first shaft end 420a, and an opposite second shaft end 420b. A blind hole 421 axially extends a predetermined length from an end opening 421a of the first shaft end 420a to an intermediate portion of the first hinge shaft 42 for partially receiving the flexible cable 28. A releasing slot 422 axially extends at a wall portion (not labeled) defining the blind hole 421. The releasing slot 422 communicates with the blind hole 421, for the flexible cable 28 to pass therethrough. The releasing slot 422 extends axially from the end opening 421a a substantially same distance as the blind hole 421, i.e. an axial length of the releasing slot 422 is substantially equal to that of the blind hole 421.

A pair of recessed portions 424 is formed on two opposite circumferential surfaces of the hinge shaft 42. The first recessed portion 424 on the lower side of the first hinge shaft 42 is constructed for engaging with the first bracket member 222. Two first through holes 426 and a first positioning hole 428 are defined through one recessed portion to the other. The two first through holes 426 correspond to the two screw holes. The first positioning hole 428 is defined for the first positioning pin 222b to insert therein.

The first positioning ring 44 includes an outer peripheral surface 440, an inner circumferential surface 442 and a pair of positioning portions 444. In the present embodiment, the positioning portions 444 are substantially planes. The positioning portions 444 are cutouts from the outer peripheral surface 440 toward the inner peripheral surface 442, for fitting in one of the first receiving holes 340 of the first receiving portion 34 of the cover 30. The inner surface 442 engages around the second shaft end 420b of the first hinge shaft 42 for generating a friction force between the second shaft end 420b and the inner surface 442 when the first positioning ring 44 is rotated with respect to the first hinge shaft 42. The friction force is sufficient for balancing the gravitational force acting on the cover 30.

The first hinge housing 46 is substantially U-shaped and includes a first sidewall 460 and a second sidewall 462. The first sidewall 460 cooperates with the second sidewall 462 to construct a receiving groove 464 for receiving the first hinge shaft 42 therebetween. A height of the first sidewall 460 is less than that of the second sidewall 462. A length of the first hinge housing 46 is less than an axial length of the first hinge shaft 42. The first and second shaft ends 421a, 421b of the first hinge shaft 42 protrude out from the first hinge housing 46. Two first clasps 466 corresponding to the first top mounting holes 228 are formed on a free edge of the first sidewall 460. Two second clasps 468 corresponding to the first side mounting holes are formed on an inner side of the second sidewall 462, adjacent to a free edge of the second sidewall 462.

Referring to FIG. 1 again, similar to the first hinge assembly 40, the second hinge assembly 50 also includes a second hinge shaft 52, a second positioning ring 54, a second hinge housing 56, and two second screws 58. Most elements of the second hinge assembly 50 are same as that of the first hinge assembly 40 except the second hinge shaft 52. The main difference between the second hinge shaft 52 and the first hinge shaft 42 is that the second hinge shaft 52 may or may not have a blind hole or a releasing slot.

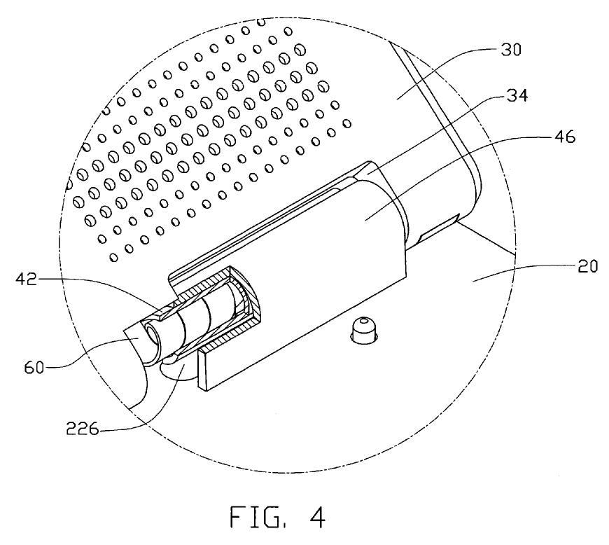

Referring also to FIG. 4, in assembly, the first positioning ring 44 is engaged around the second shaft end 420b of the first hinge shaft 42, for generating a friction force. An end of the flexible cable 28 connects to the traverse assembly 26. The flexible cable 28 passes through the releasing hole 226 and the releasing slot 422 to enter an inmost of the bind hole 420. The flexible cable 28 in the blind hole 421 is spirally extended along the axial direction of the first hinge shaft 42 and protruding out the blind hole 421 via the end opening of the first hinge shaft 42. Therefore, the portion of the flexible cable 28 that is received in the blind hole 421 is substantially configured to be a spiral. The length of the flexible cable 28 received in the blind hole 421 is greater than the axial length of the blind hole 421.

The first positioning pin 222b inserts into the first positioning hole 428 for positioning the first hinge shaft 42. The first hinge shaft 42 is supported by the first bracket member 222 via the lower first recessed portion 424 and is secured on the first bracket member 222 by the first screws 48. The first screws 48 pass through the first through holes 426 and are threaded into the corresponding screw holes. The first shaft end 420a and the second shaft end 420b are respectively accommodated in the pair of first receiving holes 340. The flexible cable 28 enters the cover 30 though the first receiving hole 340 for electrically connecting to the display unit 22.

The first hinge housing 46 covers the first hinge shaft 42. The first clasps 466 and the second clasps 468 are respectively inserted into and interlocked by the first top mounting holes 228 and the first side mounting holes.

The second hinge assembly 50 connects the base 10 to the cover 30 in the same way as the first hinge assembly 40 does. Therefore, detailed description about this section is substantially omitted.

When the cover 30 of the foldable disk player 100 is opened up, the friction force applied to the first hinge shaft 42 and the second hinge shaft 52 balances the gravitational force acting on the cover 30, and the cover 30 can thus be retained at any desired position. The first hinge shaft 42 does not rotate with the cover 30 because it is secured on the first bracket member 222. The flexible cable 28 passing through the releasing slot 422 is not liable to be broken by edges of the releasing slot 422 because the first shaft 42 is fixed well. When the cover 30 is opened and closed, the spiral of the flexible cable 28 in the blind hole 421 only deforms a little, i.e., the diameter of the spiral increases or decreases a little. Therefore, the flexible cable 28 is not subject to tension. The flexible cable is also prevented from being broken by edges at the blind hole 421. Furthermore, the flexible cable 28 is effectively protected because it is entirely packed by the first hinge shaft 42, the first hinge housing 44 and the first receiving hole 340.

In alternative embodiments, the first and second hinge housings 46, 56 may be omitted. In addition, the clasps (e.g. first clasps 466, second clasps 468) are merely used to secure the first and second hinge housings 46, 56 to the base 20, therefore, alternative structures and methods (e.g. sticking) may be used. The second hinge assembly and its corresponding structures may be omitted in case the first hinge assembly 40 alone can provide sufficient supporting force for supporting the cover. For example, the first hinge assembly 40 or its corresponding structures are configured on/in the middle of the upper casing 22 and adjacent to the rear side 224. The second positioning ring 54 may be omitted if the friction force between the first hinge shaft 42 and the first positioning ring 44 is sufficient to balance the gravitation of the cover 20. Each of the first and second bracket member 222, 223 may merely include one columnar protrusion, cuboid-shaped protrusion or other structures which can support and secure the first hinge shaft 42 or the second hinge shaft 52. The first recessed portions 424 may also be curved faces or other structures configured to be supported by the first bracket member 222. The number of the positioning portions 444 may be single or more, and the positioning portions 444 may also be a curved plane, and so on.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A hinge assembly comprising:
a hinge shaft including a first shaft end and an opposite second shaft end, a blind hole axially extending a predetermined length from the first shaft end toward the second shaft end for partially accommodating and guiding a flexible cable, the portion of the flexible cable received in the blind hole being substantially configured to be spiral, a releasing slot for the flexible cable to pass therethrough axially extending in a wall portion of the hinge shaft and communicating with the blind hole.

2. The hinge assembly as claimed in claim 1, wherein an axial length of the releasing slot is substantially equal to the predetermined length of the blind hole.

3. The hinge assembly as claimed in claim 1, wherein at least one recessed portion is formed on an outer peripheral surface of the hinge shaft.

4. The hinge assembly as claimed in claim 3, wherein the recessed portion is substantially a plane.

5. The hinge assembly as claimed in claim 1, further comprising a positioning ring engaging around the second shaft end for generating a friction force between an inner circumferential surface of the positioning ring and an outer surface of the second shaft end.

6. The hinge assembly as claimed in claim 7, wherein at least one positioning portion is recessed from an outer peripheral surface toward an inner circumferential surface of the positioning ring.

7. The hinge assembly as claimed in claim 3, wherein the recessed portion aligns with the releasing slot.

8. The hinge assembly as claimed in claim 3, wherein at least one positioning hole is defined through the recessed portion.

9. The hinge assembly as claimed in claim 1, further comprising at least one hinge housing receiving the hinge shaft, wherein an axial length of the hinge housing is smaller than that of the hinge shaft.

10. A foldable electronic apparatus comprising:
a cover including at least one receiving portion and at least one receiving hole being defined in an end of the receiving portion;
a base including a casing and at least one flexible cable, the casing defining at least one releasing hole therein, the flexible cable passing through the releasing hole and the receiving hole for electrically interconnecting the base and the cover; and
a hinge assembly received in the receiving portion, the hinge assembly including a hinge shaft, the hinge shaft including a first shaft end and an opposite second shaft end, a blind hole axially extending a predetermined length from the first shaft end toward the second shaft end, a releasing slot extending in a wall portion of the hinge shaft which defines the blind hole and communicating with the blind hole, the flexible cable extending into the blind hole via the releasing slot, the portion of the flexible cable received in the blind hole being substantially configured to be spiral.

11. The foldable electronic apparatus as claimed in claim 10, wherein an axial length of the releasing slot is substantially equal to the predetermined length of the blind hole.

12. The foldable electronic apparatus as claimed in claim 10, wherein at least one recessed portion is formed on a peripheral surface of the hinge shaft, for being mounted on the base.

13. The foldable electronic apparatus as claimed in claim 12, wherein the recessed portion aligns with the releasing slot.

14. The foldable electronic apparatus as claimed in claim 13, wherein the base includes at least one bracket member, at least one positioning hole is defined in one of the recessed portion and the bracket member, at least one positioning pin is formed on the other one of the bracket member and the recessed portion, and the positioning hole engagingly receives the positioning pin therein.

15. The hinge assembly as claimed in claim 10, further comprising a positioning ring engaging around the second shaft end for generating a friction force between an inner circumferential surface of the positioning ring and an outer surface of the second shaft end.

16. The foldable electronic apparatus as claimed in claim 15, wherein at least one positioning portion is depressed a predetermined distance from the outer peripheral surface toward the inner circumferential surface of the positioning ring, another receiving hole is defined opposite the receiving hole receiving the second shaft end for engaging with the positioning ring.

17. The foldable electronic apparatus as claimed in claim 10, wherein the hinge assembly further comprises at least one hinge housing secured on the casing, for partially receiving the hinge shaft where a length of the hinge housing is smaller than that of the hinge shaft.

18. A hinge assembly comprising:
a hinge shaft including a shaft end, the hinge shaft defining an axial hole therein with an end opening, and a releasing slot in a wall portion thereof, the releasing slot communicating with the axial hole; and
a flexible cable extending through the releasing slot into the axial hole, and extending out the hinge shaft via the end opening, the length of the flexible cable received in the axial hole being greater than an axial length the flexible cable extends in the axial hole.

19. The hinge assembly of claim 18, wherein the axial hole is a blind hole, and the releasing slot extends axially from the end opening a same length as the blind hole.

20. The hinge assembly of claim 18, wherein the flexible cable in the blind hole axially extends in a spiral manner.
